(19) United States
(12) Patent Application Publication
(10) Pub. No.: US 2009/0115764 A1
(43) Pub. Date: May 7, 2009

(54) Plasma display and driving method thereof

(76) Inventors: Jang-Ho Moon, Suwon-si (KR); Jung-Jin Choi, Suwon-si (KR); Youn-Kyoung Kim, Suwon-si (KR); Hyun Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/285,446

(22) Filed: Oct. 6, 2008

(30) Foreign Application Priority Data
Nov. 2, 2007 (KR) 10-2007-0111556

(51) Int. Cl. G09G 5/00; G09G 3/28

(52) U.S. Cl. 345/211; 345/60

(57) ABSTRACT

A method of driving a plasma display using a frame having a plurality of weighted subfields includes applying overlapping sustain pulses to first and second electrodes of the display during a sustain period of at least one subfield in the frame, and applying at least one non-overlapping sustain pulse to the first and second electrodes during the sustain period.

### BACKGROUND OF THE INVENTION

1. Field of the Invention

The present invention relates to a plasma display and a driving method thereof.

2. Description of the Related Art

A plasma display panel (PDP) is a flat panel display that uses plasma generated by gas discharge to display characters or images. One frame of the plasma display may be divided into a plurality of subfields so as to drive the plasma display. Turn-on/turn-off cells (i.e., cells to be turned on or off) may be selected during an address period of each subfield. A sustain discharge may occur a number of times corresponding to a luminance weight of a corresponding subfield in the light emitting cells during a sustain period of each subfield. Paired electrodes may be provided for performing the sustain discharge, and a plurality of address electrodes may be provided in a direction crossing the paired electrodes in the plasma display.

During the sustain period, a sustain pulse alternately having a high level voltage and a low level voltage may be applied in opposite phases to the paired electrodes. When the high level voltage of the sustain pulse is changed to the low level voltage, a self-erase discharge may be generated between the address electrodes and one of the paired electrodes performing the sustain discharge. Such a self-erase discharge may occur earlier than the sustain discharge between the pair electrodes, and therefore some wall charges may be erased. Accordingly, a subsequent sustain discharge may not be appropriately generated, the amount of wall charges may vary in the turn-on cells and the turn-off cells, and an after-image effect and/or discharge spots may occur.

The above information disclosed in this Background section is only for enhancement of understanding of the background of the invention and therefore it may contain information that does not form prior art that is already known in this country to a person of ordinary skill in the art.

### SUMMARY OF THE INVENTION

Embodiments are therefore directed to a plasma display and a driving method thereof, which substantially overcome one or more of the problems due to the limitations and disadvantages of the related art.

It is therefore a feature of an embodiment to provide a plasma display and a driving method thereof, in which overlapping sustain pulses and at least one non-overlapping sustain pulse are applied during a sustain period.

It is therefore another feature of an embodiment to provide a plasma display and a driving method thereof, in which overlapping sustain pulses and non-overlapping sustain pulses are grouped.

At least one of the above and other features and advantages may be realized by providing a method of driving a plasma display using a frame having a plurality of weighted subfields, the method including applying overlapping sustain pulses to first and second electrodes of the display during a sustain period of at least one subfield in the frame, and applying at least one non-overlapping sustain pulse to the first and second electrodes during the sustain period. The overlapping sustain pulses and the at least one non-overlapping sustain pulse may each include a maximum and minimum voltage, an overlapping sustain pulse may be a pulse during which the first and second electrodes are simultaneously at the maximum voltage for some part of the pulse, a non-overlapping sustain pulse may be a pulse during which the first and second electrodes are not simultaneously at the maximum voltage for any part of the pulse, at least two overlapping sustain pulses may be applied during a first portion of the sustain period, and the at least one non-overlapping sustain pulse may be applied during a second portion of the sustain period that is subsequent to the first portion.

The method may further include applying at least one overlapping sustain pulse then at least one non-overlapping sustain pulse to the first and second electrodes after the second portion of the sustain period. The sustain period may include a group of two or more overlapping sustain pulses followed by a group of two or more non-overlapping sustain pulses. A number of overlapping sustain pulses in the group of overlapping sustain pulses may be the same as a number of non-overlapping sustain pulses in the group of non-overlapping sustain pulses.

A group of overlapping sustain pulses and an immediately adjacent group of non-overlapping sustain pulses may form a cycle, and the cycle may occur at least once during the sustain period. The cycle may occur three times during the sustain period. The sustain period may include a group of at least two overlapping sustain pulses followed by at least one non-overlapping sustain pulse, and the sustain period may include an overlapping sustain pulse following the at least one non-overlapping sustain pulse.

The sustain period may include a first group of at least two overlapping sustain pulses followed by a first group of at least two non-overlapping sustain pulses, the first group of at least two non-overlapping sustain pulses may be followed by a second group of at least two overlapping sustain pulses, and a number of overlapping sustain pulses in the first group of overlapping sustain pulses may be greater than a number of overlapping sustain pulses in the second group of overlapping sustain pulses. The maximum voltage may be a positive voltage, and the minimum voltage may be about 0 volts.

At least one of the above and other features and advantages may also be realized by providing a plasma display, including a first electrode and a second electrode, the first and second electrodes being configured to perform a display operation in cooperation with one another, a controller configured to divide one frame into a plurality of subfields, and at least one driver configured drive the first and second electrodes, the at least one driver applying overlapping sustain pulses to the first and second electrodes during a sustain period of at least one subfield in the frame, and applying at least one non-overlapping sustain pulse to the first and second electrodes during the sustain period. The overlapping sustain pulses and the at least one non-overlapping sustain pulse may each include a maximum and minimum voltage, an overlapping sustain pulse may be a pulse during which the first and second electrodes are simultaneously at the maximum voltage for some part of the pulse, a non-overlapping sustain pulse may be a pulse during which the first and second electrodes are not simultaneously at the maximum voltage for any part of the pulse, the at least one driver may apply at least two overlapping sustain pulses during a first portion of the sustain period, and the at least one driver may apply the at least one non-overlapping sustain pulse during a second portion of the sustain period that is subsequent to the first portion.

The at least one driver may apply at least one overlapping sustain pulse then at least one non-overlapping sustain pulse to the first and second electrodes after the second portion of the sustain period. The sustain period may include a group of two or more overlapping sustain pulses followed by a group of two or more non-overlapping sustain pulses. A number of overlapping sustain pulses in the group of overlapping sustain pulses may be the same as a number of non-overlapping sustain pulses in the group of non-overlapping sustain pulses.

A group of overlapping sustain pulses and an immediately adjacent group of non-overlapping sustain pulses may form a cycle, and the cycle may occur at least once during the sustain period. The cycle may occur three times during the sustain period. The sustain period may include a group of at least two overlapping sustain pulses followed by at least one non-overlapping sustain pulse, and the sustain period may include an overlapping sustain pulse following the at least one non-overlapping sustain pulse.

The sustain period may include a first group of at least two overlapping sustain pulses followed by a first group of at least two non-overlapping sustain pulses, the first group of at least two non-overlapping sustain pulses may be followed by a second group of at least two overlapping sustain pulses, and a number of overlapping sustain pulses in the first group of overlapping sustain pulses may be greater than a number of overlapping sustain pulses in the second group of overlapping sustain pulses. The maximum voltage may be a positive voltage, and the minimum voltage may be about 0 volts.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a diagram of a plasma display according to an embodiment;

FIG. 2 illustrates a diagram of sustain pulses that all overlap;

FIGS. 3 and 4 illustrate, respectively, diagrams of a controller for the plasma display of FIG. 1 and operation thereof;

FIG. 5 illustrates a diagram of groups G1 and G3 of overlapping sustain pulses arranged with groups G2 and G4 of non-overlapping sustain pulses; and

FIG. 6 illustrates a graph of an after-image vanishment time for groupings of overlapping an non-overlapping sustain pulses.

### DETAILED DESCRIPTION OF THE INVENTION

Korean Patent Application No. 10-2007-0111556, filed on Nov. 2, 2007, in the Korean Intellectual Property Office, and entitled: “Plasma Display and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. In the drawing figures, the dimensions of layers and regions may be exaggerated for clarity of illustration. Like reference numerals refer to like elements throughout.

Herein, when it is described that a voltage is “maintained,” it does imply that the voltage is maintained exactly at a predetermined voltage. Rather, even if a voltage difference between two points varies, the voltage difference is expressed to be “maintained” at a predetermined voltage in the case that the variance is within a range allowed by design constraints, or in the case that the variance is caused by a parasitic component that is generally disregarded by a person of ordinary skill in the art.

An overlapping sustain pulse is a pulse during which the first and second electrodes are simultaneously at the maximum voltage for some part of the pulse, and a non-overlapping sustain pulse is a pulse during which the first and second electrodes are not simultaneously at the maximum voltage for any part of the pulse. Thus, the first sustain pulse overlaps the second sustain pulse when the first sustain pulse transitions from high to low while the second sustain pulse is at Vs. Such “overlapping” first and second sustain pulses may both be simultaneously Vs. Further, “non-overlapping” sustain pulses do not simultaneously have a voltage of Vs, although they may simultaneously be 0 V.

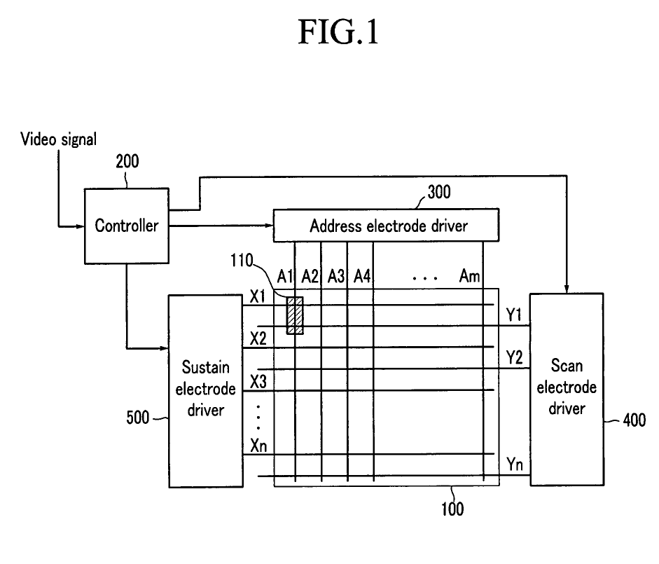

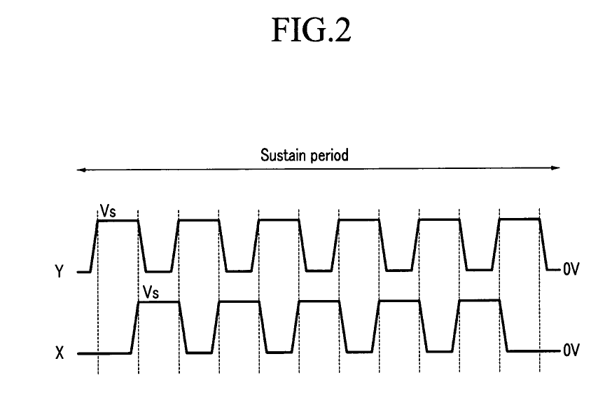

FIG. 1 illustrates a diagram of a plasma display according to an embodiment, and FIG. 2 illustrates a diagram of sustain pulses that all overlap.

Referring to FIG. 1, the plasma display may include a plasma display panel (PDP) 100, a controller 200, an address electrode driver 300, a scan electrode driver 400, and a sustain electrode driver 500.

The PDP 100 may include a plurality of address electrodes A1 to Am extending in a column direction, and a plurality of sustain and scan electrodes X1 to Xn and Y1 to Yn extending in a row direction in pairs. In general, the sustain electrodes X1 to Xn may be formed corresponding to the scan electrodes Y1 to Yn, respectively. The sustain electrodes and scan electrodes may perform a display operation for displaying an image in the sustain period. The scan electrodes Y1 to Yn and the sustain electrodes X1 to Xn are may be disposed to cross the address electrodes A1 to Am. Discharge spaces at crossing regions of the address electrodes A1 to Am and the sustain and scan electrodes X1 to Xn and Y1 to Yn may form cells. It is to be noted that this construction of the PDP is only an example, and panels having different structures, to which a driving waveform to be described later can be applied, may be used.

The controller 200 may receive an external video signal, and may output an address electrode driving control signal, a sustain electrode driving control signal, and a scan electrode driving control signal. The controller 200 may classify sustain pulses applied to the respective subfields into overlapping sustain pulses and non-overlapping sustain pulses, and may output driving control signals corresponding to overlapping sustain pulses and non-overlapping sustain pulses to the X and Y electrodes during the sustain period.

The address electrode driver 300 may apply a driving voltage to the plurality of A electrodes A1 to Am according to the driving control signal from the controller 200. The scan electrode driver 400 may apply a driving voltage to the plurality of Y electrodes Y1 to Yn according to the driving control signal from the controller 200. The sustain electrode driver 500 may apply a driving voltage to the plurality of X electrodes X1 to Xn according to the driving control signal from the controller 200.

The address, scan, and sustain electrode drivers 300, 400, and 500 may select light emitting cells and non-light emitting cells in a corresponding subfield from among the plurality of discharge cells 110 during the address period of each subfield.

During the sustain period of each subfield, as shown in FIG. 2, the scan electrode driver 400 may apply a sustain pulse alternately having a high level voltage Vs and a low level voltage 0V to the plurality of Y electrodes Y1 to Yn a number of times corresponding to a weight value of the corresponding subfield. In addition, the sustain electrode driver 500 may apply a sustain pulse, having an opposite phase to that applied to the Y electrodes Y1 to Yn, to the plurality of X electrodes X1 to Xn. Thus, a difference between each Y electrode and each X electrode may alternately be a Vs voltage and a −Vs voltage. Therefore, a sustain discharge may be repeatedly generated in a turn-on discharge cell a predetermined number of times.

The sustain pulse applied to the Y electrode during the sustain period may be partially overlapped with the sustain pulse that is applied to the X electrode immediately after the sustain pulse applied to the Y electrode during the sustain period. Thus, while the Vs voltage is applied to the X electrode, a voltage at the Y electrode may be decreased from the Vs voltage to the 0V voltage for a predetermined time after the Vs voltage is applied to the X electrode. Further, while the Vs voltage is applied to the Y electrode, a voltage of the X electrode may be decreased from the Vs voltage to the 0V voltage for a predetermined time after the Vs voltage is applied to the Y electrode.

Using the above-described sustain pulses, the A electrode may become a cathode with respect to the Y electrode (or the X electrode), and a discharge between the Y and X electrodes may be generated earlier than a self-erase discharge between the Y electrode (or the X electrode) and the A electrode.

A discharge in a cell is determined by the amount of secondary electrons emitted from the cathode when positive ions collide against the cathode, which is referred to as a γ process. In the PDP, phosphors may cover the A electrode to express colors, and materials having a high secondary electron emission coefficient, such as an MgO protective layer, may cover the X and Y electrodes to increase sustain discharge efficiency. Accordingly, since the A electrode covered with the phosphors functions as the cathode when a voltage between the A and Y electrodes exceeds a discharge firing voltage, the discharge between the A electrode and the Y electrode (or the X electrode) is delayed. Thus, the self-erase discharge is generated between the A electrode and the Y electrode (or the X electrode) while the voltage at the Y electrode (or the X electrode) is decreased from the Vs voltage to the 0V voltage, and the sustain discharge is generated between the X and Y electrodes before the wall charges are eliminated. Therefore, an after-image effect or discharge spots may be prevented, and a subsequent sustain discharge may be stably generated.

When the sustain pulse shown in FIG. 2 is applied during the sustain period, an impact on the MgO protective layer covering the Y and X electrodes may be increased. Accordingly, a life-span of the PDP may be reduced, and a luminance maintenance rate may decrease. Therefore, the self-erase discharge may be reduced or prevented by using a non-overlapping sustain pulse applied to the X and Y electrodes.

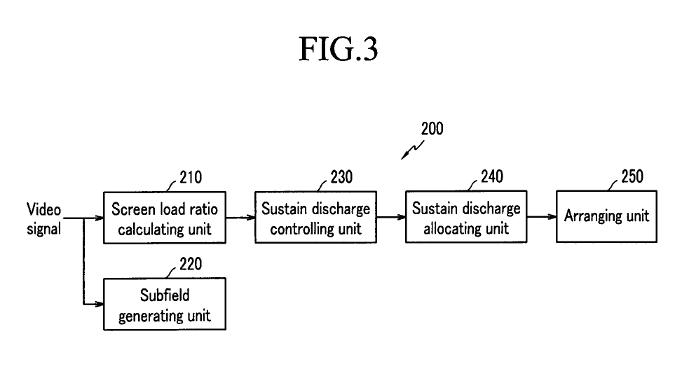

An example method of using a non-overlapping sustain pulse for preventing the deterioration of the luminance maintenance rate and the self-erase discharge according to an embodiment will be described with reference to FIGS. 3 to 6.

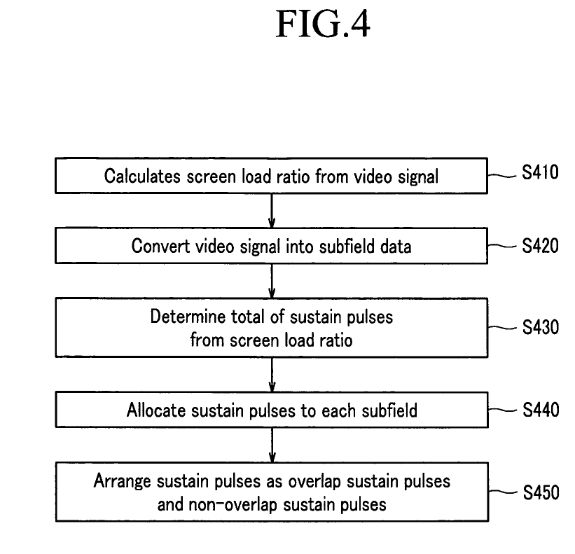

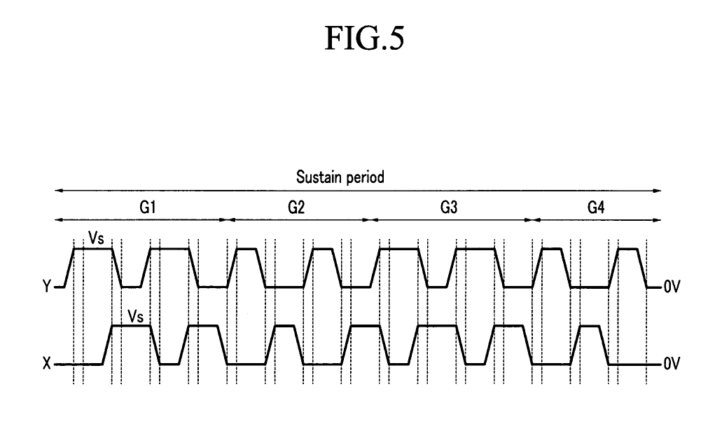

FIGS. 3 and 4 illustrate, respectively, diagrams of a controller for the plasma display of FIG. 1 and operation thereof, and FIG. 5 illustrates a diagram of groups G1 and G3 of overlapping sustain pulses arranged with groups G2 and G4 of non-overlapping sustain pulses.

Referring to FIG. 3, the controller 200 may include a screen load ratio calculating unit 210, a subfield generating unit 220, a sustain discharge controlling unit 230, a sustain discharge allocating unit 240, and an arranging unit 250.

The screen load ratio calculating unit 210 may calculate a screen load ratio from the plurality of video signals input for one frame in operation S410. For example, the screen load ratio may be calculated from an average signal level of the video signals of one frame. The plurality of video signals may respectively correspond to the plurality of discharge cells 110 shown in FIG. 1.

The subfield generating unit 220 may convert the plurality of video signals into a plurality of subfield data in operation S420.

The sustain discharge controlling unit 230 may determine a total number of sustain pulses allocated to one frame according to the screen load ratio in operation S430. The sustain discharge controlling unit 230 may store the total number of sustain pulses determined according to the screen load ratio in a look-up table, or may calculate the total number of sustain pulses by performing a logic operation on the data corresponding to the screen load ratio. Thus, when the number of light emitting cells is increased and the screen load ratio is increased, the total number of sustain pulses may be decreased to prevent an increase of power consumption.

The sustain discharge allocating unit 240 may respectively allocate the sustain pulses in proportion to the luminance weight values in operation S440.

The arranging unit 250 may arrange the sustain pulses as overlapping sustain pulses and non-overlapping sustain pulses, and may apply driving control signals according to the arranged sustain pulses to the scan and sustain electrode drivers 400 and 500 in step S450. The arranging unit 250 may first provide overlapping sustain pulses, e.g., two or more. Accordingly, the sustain discharge may be generated, before the wall charges are eliminated by self-erase discharge, and a strong sustain discharge may be generated. Therefore, the wall charges may be sufficiently formed on the X and Y electrodes. In addition, after the wall charges are sufficiently formed on the X and Y electrodes, the self-erase discharge may not occur when the non-overlapping sustain pulse is applied to the X and Y electrodes.

The sustain discharge may be maintained by the amount of wall charges of the X and Y electrodes that are formed by the sustain discharge generated at an early stage of the sustain period. Accordingly, the arranging unit 250 may allocate two or more overlapping sustain pulses that are firstly arranged. One overlapping sustain pulse may be formed by combining one sustain pulse applied to the Y electrode and one sustain pulse, that is subsequent to the sustain pulse applied to the Y electrode, to be applied to the X electrode.

In an implementation, the arranging unit 250 may allocate four or more overlapping sustain pulses during the sustain period, and the number of overlapping sustain pulses may be reduced as time goes on in the sustain period. For example, when the number of sustain pulses allocated to one subfield is 20, the arranging unit 250 may arrange four overlapping sustain pulses, then four non-overlapping sustain pulses, and then two overlapping sustain pulses. In an implementation, the arranging unit 250 may allocate the overlapping and non-overlapping sustain pulses during the sustain field regardless of the weight of the subfield, i.e., a same arrangement of overlapping and non-overlapping sustain pulses may be used for each subfield of the frame.

Referring to FIG. 5, the controller 200 may arrange two overlapping sustain pulses, and may subsequently arrange two non-overlapping sustain pulses. In addition, the controller 200 may perform a cycle of arranging two overlapping sustain pulses and arranging two non-overlapping sustain pulses, which may be repeated until reaching the number of sustain pulses allocated to the sustain period of the corresponding subfield.

In an implementation, the arranged sustain pulses applied to the X and Y electrodes during the sustain period may be divided into a plurality of groups, e.g., G1 to G4 as shown in FIG. 3, according to type, i.e., the overlapping waveform and the non-overlapping waveform. Two sustain pulses of the overlapping waveform may be applied to a first group G1, such that the sustain discharge may be sufficiently generated between the X and Y electrodes, as described above, before the wall charges are eliminated by self-erase discharge. Therefore, the wall charges may be sufficiently formed on the X and Y electrodes.

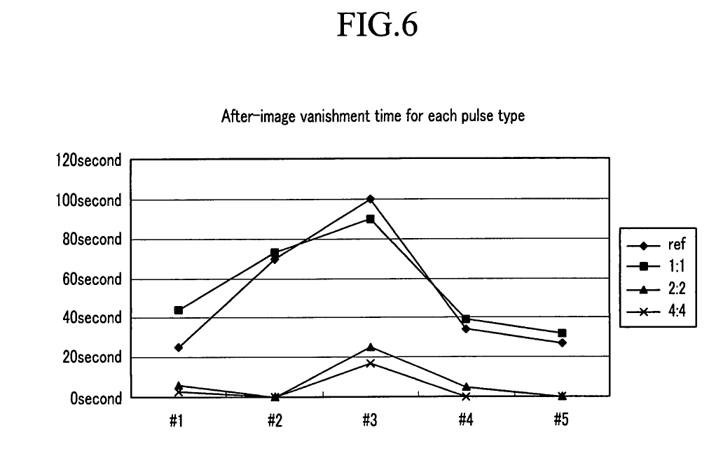

FIG. 6 illustrates a graph of an after-image vanishment time for groupings of overlapping an non-overlapping sustain pulses. In FIG. 6, the vertical axis indicates the after-image vanishment time. The “#” symbol along the x-axis denotes a number of cycle occurrences. Also, the legends “1:1,” “2:2,” and “4:4” denote the number of sustain pulses of the overlapping waveform and the number of sustain pulses of the non-overlapping waveform. For example, when the number of repeat times is #3 and the numbers of overlapping and non-overlapping sustain pulses are 2:2 (a group of two overlapping and a group of two non-overlapping), overlapping sustain pulses were applied to the X and Y electrodes twice and then non-overlapping sustain pulses were applied to the X and Y electrodes twice, which cycle was performed for a total of three cycles. The legend “ref” denotes a non-overlapping sustain pulse, i.e., only non-overlapping sustain pulses were applied to the X and Y electrodes during the sustain period.

As shown in FIG. 6, the after-image vanishment time was slightly reduced in the sustain pulse of 1:1 when the number of repeat times is #3. Further, the after-image vanishment time was reduced in the sustain pulse groupings of 2:2 and 4:4 for each of #1 through #5. Thus, at least two or more subsequent sustain pulses respectively applied to the X and Y electrodes were in the groups G1 to G4 (see FIG. 5) and, with the overlapping sustain pulse applied in the first group G1, the after-image vanishment time was considerably reduced.

As discussed above, during the sustain period, sustain waveforms of generally opposite phase, each waveform alternately having a high level voltage and a low level voltage, may be applied to two electrodes to perform a sustain discharge. In particular, when the high level voltage of the sustain pulse of a first electrode transitions low, i.e., changes to the low level voltage, a self-erase discharge may generated between an address electrode and one of the two electrodes performing the sustain discharge, and such self-erase discharge may occur before the sustain discharge generated between the two sustain electrodes. Therefore, some wall charges may be erased.

The sustain pulse applied to the Y electrode during the sustain period may partially overlap with the sustain pulse applied to the X electrode immediately after the sustain pulse applied to the Y electrode during the sustain period, i.e., both electrodes may be simultaneously at Vs. Accordingly, a discharge between the Y and X electrodes may be generated before a self-erase discharge occurs between the Y electrode (or the X electrode) and the A electrode. Thus, self-erase may be avoided by using overlapping sustain pulses. When the overlapping sustain pulse shown in FIG. 2 is applied during the sustain period, negative effects on the MgO protective layer covering the Y and X electrodes may increase. Thus, overlapping sustain pulses implemented to prevent self-erasing may result in undesirable deterioration of the MgO layer, such that a life-span of the PDP may be reduced. Therefore, the use of non-overlapping sustain pulses according to an embodiment may allow the self-erase discharge to be prevented, while reducing or eliminating degradation of the MgO layer and thereby preserving the luminance of the PDP. Moreover, grouping of overlapping and non-overlapping sustain pulses may further reduce after-image effects and discharge spots.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving a plasma display using a frame having a plurality of weighted subfields, the method comprising:
applying overlapping sustain pulses to first and second electrodes of the display during a sustain period of at least one subfield in the frame; and
applying at least one non-overlapping sustain pulse to the first and second electrodes during the sustain period, wherein:
the overlapping sustain pulses and the at least one non-overlapping sustain pulse each includes a maximum and minimum voltage,
an overlapping sustain pulse is a pulse during which the first and second electrodes are simultaneously at the maximum voltage for some part of the pulse,
a non-overlapping sustain pulse is a pulse during which the first and second electrodes are not simultaneously at the maximum voltage for any part of the pulse,
at least two overlapping sustain pulses are applied during a first portion of the sustain period, and
the at least one non-overlapping sustain pulse is applied during a second portion of the sustain period that is subsequent to the first portion.

2. The method as claimed in claim 1, further comprising applying at least one overlapping sustain pulse then at least one non-overlapping sustain pulse to the first and second electrodes after the second portion of the sustain period.

3. The method as claimed in claim 1, wherein the sustain period includes a group of two or more overlapping sustain pulses followed by a group of two or more non-overlapping sustain pulses.

4. The method as claimed in claim 3, wherein a number of overlapping sustain pulses in the group of overlapping sustain pulses is the same as a number of non-overlapping sustain pulses in the group of non-overlapping sustain pulses.

5. The method as claimed in claim 3, wherein:
a group of overlapping sustain pulses and an immediately adjacent group of non-overlapping sustain pulses forms a cycle, and
the cycle occurs at least once during the sustain period.

6. The method as claimed in claim 5, wherein the cycle occurs three times during the sustain period.

7. The method as claimed in claim 1, wherein:
the sustain period includes a group of at least two overlapping sustain pulses followed by at least one non-overlapping sustain pulse, and
the sustain period includes an overlapping sustain pulse following the at least one non-overlapping sustain pulse.

8. The method as claimed in claim 7, wherein:
the sustain period includes a first group of at least two overlapping sustain pulses followed by a first group of at least two non-overlapping sustain pulses,
the first group of at least two non-overlapping sustain pulses is followed by a second group of at least two overlapping sustain pulses, and
a number of overlapping sustain pulses in the first group of overlapping sustain pulses is greater than a number of overlapping sustain pulses in the second group of overlapping sustain pulses.

9. The method as claimed in claim 1, wherein:
the maximum voltage is a positive voltage, and
the minimum voltage is about 0 volts.

10. A plasma display, comprising:
a first electrode and a second electrode, the first and second electrodes being configured to perform a display operation in cooperation with one another;
a controller configured to divide one frame into a plurality of subfields; and
at least one driver configured drive the first and second electrodes, the at least one driver applying overlapping sustain pulses to the first and second electrodes during a sustain period of at least one subfield in the frame, and applying at least one non-overlapping sustain pulse to the first and second electrodes during the sustain period, wherein:
the overlapping sustain pulses and the at least one non-overlapping sustain pulse each includes a maximum and minimum voltage,
an overlapping sustain pulse is a pulse during which the first and second electrodes are simultaneously at the maximum voltage for some part of the pulse,
a non-overlapping sustain pulse is a pulse during which the first and second electrodes are not simultaneously at the maximum voltage for any part of the pulse,
the at least one driver applies at least two overlapping sustain pulses during a first portion of the sustain period, and
the at least one driver applies the at least one non-overlapping sustain pulse during a second portion of the sustain period that is subsequent to the first portion.

11. The display as claimed in claim 10, wherein the at least one driver applies at least one overlapping sustain pulse then at least one non-overlapping sustain pulse to the first and second electrodes after the second portion of the sustain period.

12. The display as claimed in claim 10, wherein the sustain period includes a group of two or more overlapping sustain pulses followed by a group of two or more non-overlapping sustain pulses.

13. The display as claimed in claim 12, wherein a number of overlapping sustain pulses in the group of overlapping sustain pulses is the same as a number of non-overlapping sustain pulses in the group of non-overlapping sustain pulses.

14. The display as claimed in claim 12, wherein:
a group of overlapping sustain pulses and an immediately adjacent group of non-overlapping sustain pulses forms a cycle, and
the cycle occurs at least once during the sustain period.

15. The display as claimed in claim 14, wherein the cycle occurs three times during the sustain period.

16. The display as claimed in claim 10, wherein:
the sustain period includes a group of at least two overlapping sustain pulses followed by at least one non-overlapping sustain pulse, and
the sustain period includes an overlapping sustain pulse following the at least one non-overlapping sustain pulse.

17. The display as claimed in claim 16, wherein:
the sustain period includes a first group of at least two overlapping sustain pulses followed by a first group of at least two non-overlapping sustain pulses,
the first group of at least two non-overlapping sustain pulses is followed by a second group of at least two overlapping sustain pulses, and
a number of overlapping sustain pulses in the first group of overlapping sustain pulses is greater than a number of overlapping sustain pulses in the second group of overlapping sustain pulses.

18. The display as claimed in claim 10, wherein:
the maximum voltage is a positive voltage, and
the minimum voltage is about 0 volts.
